(19) United States
(12) Patent Application Publication
(10) Pub. No.: US 2006/0130390 A1
(43) Pub. Date: Jun. 22, 2006

(54) Apparatus and methods for banding tree trunks

(75) Inventors: John Barilovits, Gray Court, SC (US); Steve Barilovits, Charlotte, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tree Banding Services LLC

(21) Appl. No.: 11/015,298

(22) Filed: Dec. 17, 2004

(51) Int. Cl. A01M 1/18; A01G 13/02

(52) U.S. Cl. 43/108

(57) ABSTRACT

A tree band trap includes a formfitting substance engaging and extending around the trunk's outer circumference, a stretchable strip mounted to the trunk and having a length extending in a longitudinal direction and around the formfitting substance's outer circumference, and a deterring agent extending around the stretchable strip's outer circumference for deterring insects from traversing the stretchable strip. The stretchable strip is operative so that, after the stretchable strip is mounted to the trunk, the stretchable strip is under tension in the longitudinal direction as a result of the stretchable strip having been stretched, and the tension of the stretchable strip forces the formfitting substance against the trunk's outer circumference. A marginal portion of the stretchable strip extends around the trunk's outer circumference at a position that is above and/or below the formfitting substance. A deflector is provided for deflecting falling leaves away from the deterring agent.

### BACKGROUND OF THE INVENTION

The present invention pertains to protecting plants from crawling insects and, more particularly, to placing bands around trunks of trees or shrubs to deter insects from crawling up or down the trunks.

“Tree banding” is a known method of controlling crawling insects that damage trees and shrubs. Insects controlled by tree banding include several types of wingless moths and other crawling insects that make their way up tree trunks after pupating at or below ground level. Insects controlled by tree banding also include some insects and caterpillars that move up and down tree trunks daily to avoid predators and extremes of temperature. Tree bands are a type of trap or barrier that takes advantage of these natural movements of the insects.

A very simple type of prior art tree band trap solely includes an annular coating of a durably sticky substance applied directly to the trunk of the tree. The durably sticky substance can be one or more substances including petroleum jelly, bearing grease, sticky paper, or products manufactured specifically for this purpose. This type of tree band trap (i.e., the sticky coating) is applied so that it is a few inches wide and extends around the circumference of the tree trunk somewhat above ground. The sticky tree band trap acts as a barrier because if the insects try to move through or across the sticky tree band trap, they become entrapped by it. This method of applying the sticky material directly to the tree trunk is unsightly and leaves a semipermanent residue on the tree. This method is typically used only in commercial agricultural operations.

Another prior art tree band trap is removable and does not involve applying the sticky substance directly to the tree. Rather, this tree band trap includes a band of asphalt-saturated paper (i.e., tar paper) affixed to the circumference of the tree trunk. The paper is attached to the tree with staples or roofing nails. The sticky substance is then applied to the outer surface of the tar paper. While this method prevents the sticky substance from being applied directly to the tree, the tar paper has been found to wick the oils and solvents from the sticky substance, causing it to become less tacky. Furthermore, insects have been found to crawl under the tar paper at undulations in the tree's trunk and via fissures in the tree's bark.

To prevent the insects from crawling under the tar paper, it is known in the prior art to apply an annular layer of fibrous material, such as fiberglass, cotton, or synthetic batting, around the circumference of the tree trunk before the tar paper is affixed. FIG. 1 is a schematic, elevational view of a portion of a trunk 10 of a tree with this type of prior art tree band trap 12 extending around the trunk. More specifically, FIG. 1 illustrates the tar paper 14 extending around the circumference of the trunk 10 and attached thereto by mechanical fasteners 16, such as nails or staples. Only a few of the mechanical fasteners are identified by their reference numeral in FIG. 1 in an effort to clarify the view. In FIG. 1, the sticky substance 18 is seen adhered to and extending around the outer circumference of the tar paper 14, and the fibrous material is generally hidden from view behind the tar paper 14, at a position that is between the upper and lower rows of mechanical fasteners 16. FIG. 2 is a schematic, cross-sectional view of a portion of the trunk 10 and prior art tree band trap 12; therefore, the fibrous material 20 is shown.

Another prior art tree band trap 22 is illustrated in FIGS. 3 and 4. This tree band trap 22 is sold as a kit that basically includes two items. The first item is a length of synthetic fiber batting 24 that is about 3 inches wide and 1 thick. The second item is a nonstretchable, semirigid plastic strip 26 having a width of 6 inches and a thickness of about 0.010 inches. The plastic strip 26 has a preapplied (i.e., applied at the factory) adhesive coating (not illustrated in FIGS. 3 and 4) that covers what will be the inwardly oriented surface 28 of the plastic strip. Likewise, a release paper (not illustrated in FIGS. 3 and 4) is preapplied (i.e., applied at the factory) over the adhesive coating.

The tree band trap 22 is significantly different from the tree band trap 10 described above. The tree band trap 22 is installed by wrapping the fiber batting 24 around the tree trunk 30 to prevent insects from crawling between the tree band trap 22 and the trunk 30. The user is instructed to wrap the batting 24 twice around the trunk, with the second layer directly over the first. After the layers of batting 24 have been applied to the trunk, the release paper is removed from the nonstretchable, semirigid plastic strip 26 and discarded. The plastic strip 26 is then placed on the batting 24, while aligning the upper edge of the 3 inch wide layers of batting with the upper edge of the 6 inch wide plastic strip 26. The plastic strip 26 is to be applied with the adhesive-coated surface 28 facing the tree trunk 30. The plastic strip 26 is overlapped upon itself to hold itself in place, very much like a wide piece of tape.

Care must be taken not to pull the plastic strip 26 too tightly about the trunk 30 when securing it at the point of overlap. It is the thickness of the double layers of batting 24 which is expected to keep the adhesive-coated side 28 of the plastic strip 26 from contacting the trunk 30. If too much tension is put on the plastic strip 26, the layers of batting 24 become too compressed, allowing the adhesive-coated side 28 of the plastic strip 26 to contact, and become adhered to, the trunk 30, which can cause the tree band trap 22 to malfunction.

In order for the tree band trap 22 to function properly, the adhesive-coated side 28 of the plastic strip 26 is to be facing, yet spaced apart from, the trunk 30. Then, the insects moving up the trunk 30 crawl upwardly past the lower edge of the plastic strip 26 until they encounter the batting 24. If the insects crawl across the thickness of the batting 24, they will then encounter, and become adhered to, the adhesive-coated side 28 of the plastic strip 26.

Other tree band traps are also known from U.S. Pat. No. 4,766,695.

Although numerous tree band traps are known, there is always a desire for improved tree band traps and/or barriers because, for example, improvements in reliability and ease of use of these items will promote their use and thereby help to protect our trees from infestation.

### BRIEF SUMMARY OF SOME ASPECTS OF THE INVENTION

One aspect of the present invention is the provision of improved apparatus and methods for banding trunks of trees. Advantageously, tree band traps of the present invention can be more reliable and durable, efficient, and easier to use as compared to at least some of the prior art tree band traps. In accordance with one embodiment of the present invention, other advantages include: the tree band trap requiring no adhesives, adhesive tape, or mechanical fasteners to secure the tree band trap to the tree trunk; the tree band trap being tamperproof with respect to animals such as squirrels and birds; and there being no wasted material when the tree band trap is applied to a tree trunk.

In accordance with one aspect of the present invention, a tree band trap includes a formfitting substance (e.g., batting) engaging and extending at least substantially around the outer circumference of a tree trunk, a stretchable strip (e.g., elastic film) mounted to the trunk and having a length extending in a longitudinal direction and at least substantially around the formfitting substance's outer circumference, and a deterring agent (e.g., a durably sticky substance) extending at least substantially around the stretchable strip's outer circumference. The formfitting substance deters insects from traveling between the trunk and the tree band trap, and the deterring agent deters the insects from traveling across the exterior of the tree band trap. Advantageously, the stretchable strip is operative so that, after the stretchable strip is mounted to the trunk, the stretchable strip is under tension in the longitudinal direction as a result of the stretchable strip having been stretched, and the tension of the stretchable strip forces the formfitting substance against the trunk's outer circumference.

It is preferred for a marginal portion of the stretchable strip to extend substantially around the trunk's outer circumference at a position that is above and/or below the formfitting substance. It is also preferred for the formfitting substance and the stretchable strip to be substantially nonadhesive. That is, preferably neither the formfitting substance nor the stretchable strip includes or carries an adhesive that is tacky (e.g., an adhesive with a solvent that has not yet been substantially volatilized) at the time the tree band trap is installed. In one example, the tree band trap only includes the formfitting substance, the stretchable strip and the deterring agent. Alternatively, pieces of adhesive tape, or other fasteners, such as mechanical fasteners, can be used to secure or partially secure the formfitting substance and the stretchable strip.

Although not necessarily required, it is preferred, as mentioned above, for a marginal portion of the stretchable strip to extend substantially around the trunk's outer circumference at a position that is above and/or below the formfitting substance. In accordance with one aspect of the present invention, this marginal portion is a first annular marginal portion of the stretchable strip that engages and extends substantially around the trunk's outer circumference at a position above the formfitting substance. In addition, a second annular marginal portion of the stretchable strip can engage and extend substantially around the trunk's outer circumference at a position below the formfitting substance. As a result, and advantageously, the formfitting substance is substantially enclosed between the trunk and the stretchable strip. In addition, the stretchable strip can be opaque, so that the formfitting substance is substantially hidden from view. This can advantageously deter squirrels and birds from tearing into the tree band trap and carrying the formfitting substance away. Depending upon the type of formfitting substance used, if squirrels and birds could see it, they may desire to access it and use it for building their nests.

The stretchable strip can be a polymeric film, such as polymeric film having a width of about 10 inches and a thickness of about 0.0009 inches. The width of the polymeric film is preferably wider than the width of the preferably strip-like formfitting substance. These differences in widths allow for one or both of the margins of the stretchable strip to easily extend beyond the corresponding edge of the formfitting substance, as mentioned above.

The formfitting substance can consist solely of a fibrous strip, or it can be a composite strip including a fibrous material mounted to a backing strip. In either case, it is preferred for the fibrous material to be in face-to-face engagement with the trunk of the tree. The fibrous material can be fiberglass, or the like, and the backing strip can be kraft paper, or the like. If the formfitting substance consists solely of a fibrous strip, it is preferred for another strip, such as a strip of kraft paper, or the like, to be interposed between the fibrous strip and the stretchable strip.

In accordance with one aspect of the present invention, the deterring agent is, or includes, a sticky substance that remains substantially tacky for at least about a month and preferably longer, and the sticky substance is for causing the insects to become adhered to the tree band trap. Although it is preferred for the deterring agent to be a natural sticky substance, the deterring agent can further include, or can alternatively be, a pesticide for killing the targeted insects.

In accordance with one aspect of the present invention, portions of the stretchable strip are in face-to-face engagement with one another, and the stretchable strip is operative so that this face-to-face engagement at least partially causes the stretchable strip to be mounted to the trunk of the tree. For example, the portions of the stretchable strip that are in face-to-face engagement with one another can be first and second portions of the stretchable strip that were initially spaced apart from one another along the length of the stretchable strip. More specifically, the second portion of the stretchable strip can be sandwiched between the first portion of the stretchable strip and structure such as a third portion of the stretchable strip and/or the formfitting substance and/or the trunk.

In accordance with one aspect of the present invention, the tree band trap is applied to the trunk in accordance with a method in which the formfitting substance is positioned so that it engages and extends at least substantially around the trunk's outer circumference, and thereafter the stretchable strip is mounted to the trunk. In accordance with this method, it is preferred for the deterring agent to be applied after the stretchable strip is mounted to the trunk, and preferably the deterring agent is applied directly onto the outer circumference of the stretchable strip. It is preferred for the formfitting substance to initially be separate from the stretchable strip and to be applied to the trunk prior to the stretchable strip so that the stretchable strip can be stretched and tensioned without requiring that the formfitting substance undergo substantially the same stretching as the stretchable strip. This preferred independence between the stretchable strip and the formfitting substance can advantageously allow optimization of their respective properties.

In accordance with one aspect of the present invention, a deflector is provided for deflecting debris, such as leaves, so that the debris does not impair the operativeness of the deterring agent. The deflector can be positioned above the tree band trap of the present invention, or it can be positioned above another item or area that is to be protected from falling debris, such as leaves. In one example, the deflector includes a plurality of projecting pieces which extend away from the trunk and are arranged so that a series of elongate openings are respectively defined between the projecting pieces. For each of the openings, the opening tapers so that it becomes wider at greater distances from the trunk.

The deflector preferably includes a base from which the projecting pieces extend, with the base and the projecting pieces being parts of a single strip of material. The base can be mounted to the tree band trap, such as by sandwiching the base between at least one layer of the stretchable strip and the trunk.

In accordance with one aspect of the present invention, components of the tree band trap, with or without the deflector, are supplied in the form of a kit.

Other features and advantages of the present invention will be apparent to those of ordinary skill in the art in view of the following.

### BRIEF DESCRIPTION OF THE DRAWINGS

Having thus described the invention in general terms, reference will now be made to the accompanying drawings, which are not necessarily drawn to scale, and wherein:

FIG. 1 is a schematic, elevational view of a portion of a tree trunk with a prior art tree band trap extending there-around, and FIG. 1 is generally illustrative of all elevational views of the prior art tree band trap extending around the trunk;

FIG. 2 is a schematic, cross-sectional view of a portion of the trunk and tree band trap of FIG. 1, with the cross-section taken along the central vertical axis of the trunk, and FIG. 2 is generally illustrative of all cross-sections of the trunk and tree band trap taken along the central vertical axis of the trunk;

FIG. 3 is a schematic, elevational view of a portion of a tree trunk with a prior art tree band trap extending there-around, and FIG. 3 is generally illustrative of all elevational views of the trunk with the prior art tree band trap extending around the trunk;

FIG. 4 is a schematic, cross-sectional view of a portion of the trunk and tree band trap of FIG. 3, with the cross-section taken along the central vertical axis of the trunk, and FIG. 4 is generally illustrative of all cross-sections of the trunk and tree band trap taken along the central vertical axis of the trunk;

FIG. 5 is a schematic, elevational view of a portion of a tree trunk with a tree band trap extending there-around, in accordance with an exemplary embodiment of the present invention, and FIG. 5 is generally illustrative of all elevational views of the tree band trap extending around the trunk, except with respect to an end of the elastic film of the tree band trap being tucked behind another portion of the elastic film for fastening purposes, as partially illustrated by broken lines in FIG. 5.

FIG. 6 is a schematic, cross-sectional view of the trunk and tree band trap of FIG. 5, with the cross-section taken along the central vertical axis of the trunk, and FIG. 5 is generally illustrative of all cross-sections of the trunk and tree band trap taken along the central vertical axis of the trunk, when disregarding the tucking of the end of the elastic film;

FIG. 7 is an enlarged view of a portion of FIG. 6;

FIG. 8 is an isolated plan view of a deflector in a flattened configuration, in accordance with the exemplary embodiment of the present invention;

FIG. 9 is a schematic, cross-sectional view of the deflector of FIG. 8 mounted to the exterior of the tree band trap of FIGS. 5-7, with the cross-section taken along the central vertical axis of the trunk, and FIG. 9 is generally illustrative of all cross-sections of the combination of the deflector, trunk and tree band trap taken along the central vertical axis of the trunk, when disregarding the tucking of the end of the piece of the elastic film;

FIG. 10 is like FIG. 9, except that the deflector is mounted at least partially by virtue of a portion of the deflector being sandwiched between a portion of the tree band trap and the trunk;

FIG. 11 is a schematic view that is generally illustrative of top plan views of that which is illustrated in FIGS. 9 and 10; and

FIG. 12 schematically illustrates a top plan view of an upright bag that is open at the top and contains unassembled components of the tree band trap and deflector therein, whereby FIG. 12 is illustrative of a kit, in accordance with the exemplary embodiment of the present invention.

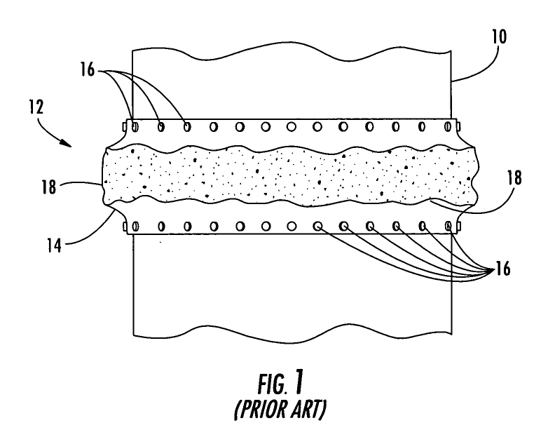

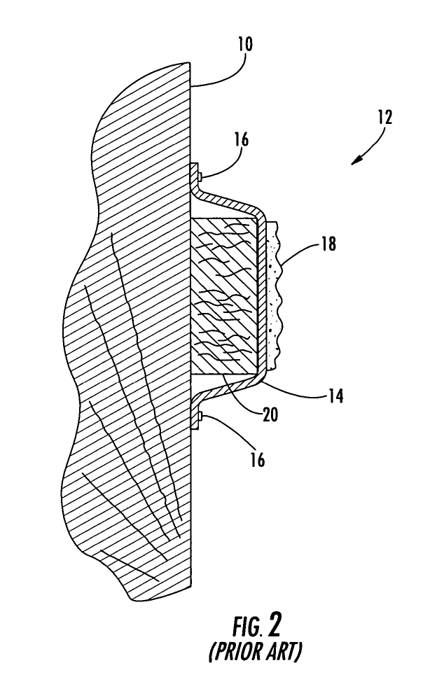

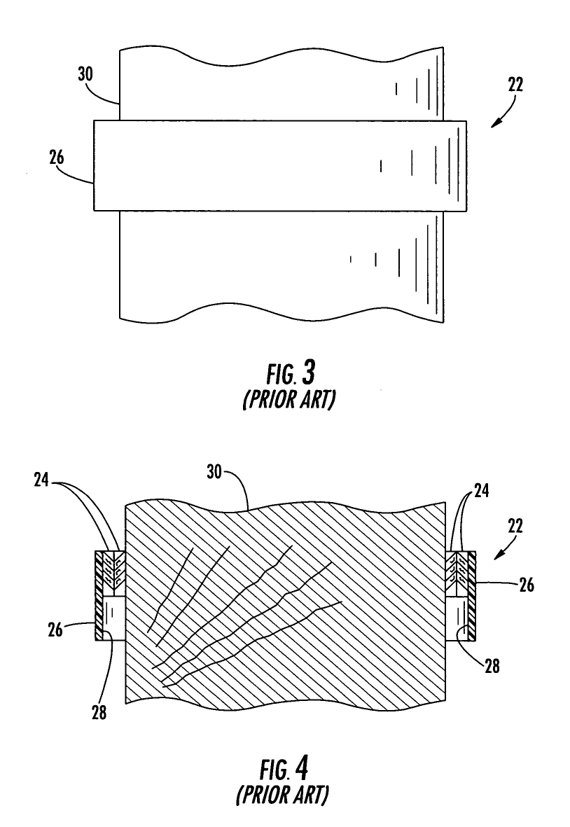

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The present invention provides methods and apparatus that can be advantageously used for banding trunks of plants, for deterring insects from traveling along the trunks. In this section of this disclosure, the methods and apparatus are described primarily in the context of banding tree trunks, in accordance with an exemplary embodiment of the present invention. Nonetheless, the methods and apparatus of the present invention can be used for banding trunks of other plants, such as, but not limited to, the trunks of bushes.

FIGS. 5-7 illustrate a tree band trap 32 that is mounted to a trunk 34, in accordance with the exemplary embodiment of the present invention. The trap 32 includes a formfitting substance that is preferably in the form of a strip of fibrous batting 36, or the like. The batting 36 engages and extends substantially around, and preferably completely around, the outer circumference of the trunk 34. The trap 32 also includes a stretchable strip that is preferably in the form of a substantially stretchable and elastic film 38, or the like. The film 38 has a length extending in a longitudinal direction around the outer circumference of the batting 36. The film 38 is preferably tensioned in the longitudinal direction as a result of the film having been stretched during installation, so that the film forces the batting 36 against the outer circumference of the trunk 34. Lastly, the trap 32 includes an insect-deterring agent that is preferably in the form of a sticky substance 40, and can alternatively be in the form of a structure and/or a pesticide or any other feature or combination of features that will have the effect of protecting the tree from the insects being targeted. The sticky substance 40 extends substantially around, and preferably completely around, the outer circumference of the film 38.

Installation of, and the components of, the trap 32 will now be described in greater detail, in accordance with the exemplary embodiment of the present invention. First, a length of the batting 36, preferably with an integral backing 42, or the like, is applied around the trunk 34, so that the batting 36 is in direct face-to-face engagement with the trunk 34 and thereby sandwiched between the outer circumference of the trunk 34 and the inner circumference of the backing 42. Preferably only a single strip of the batting 36 is applied so that it fully encircles the trunk 34 and so that its opposite ends abut one another or overlap slightly.

It is preferred for the width and expandable thickness of the batting 36 to be selected so that the batting is operative for sufficiently filling most of the typical undulations in the curvature of the trunk 34 and the fissures in its bark, so that the trap 32 only needs a single layer of the batting. In accordance with the exemplary embodiment of the present invention, the batting 36 is produced with one surface along its length covered with the semirigid strip of backing 42. The backing 42 can be formed at least partially of wood pulp, and more specifically it can be kraft paper, or the like. The backing 42 advantageously stiffens the surface of the batting 36 that includes the backing 42. One purpose of this backing 42 is to cooperate with the film 38 to provide a consistently smooth outer circumferential area of the film 38 upon which the sticky substance 40 can be conveniently applied. In one embodiment, large rolls of preformed, commercially available batting are cut into strips having a predetermined width. The batting 36 can be replaced with other types of formfitting substances that provide the desired function(s). Likewise, the backing 42 can be any type of material that provides the desired function(s).

Acceptable batting 36, which incorporates the backing 42, can be cut from residential fiberglass insulation with a kraft paper backing. An acceptable fiberglass insulation with a kraft paper backing, which can be cut to size for the purposes of the first embodiment of the present invention, is available from Owens-Corning and is identified by product/code #13L41/146 or 13L69/784. The batting 36 of the trap 32 can have a width of about 1 inch to about 6 inches, or a width of about 2 inches to about 5 inches. The batting 36 can have a thickness (before being compressed) of about 1; inch to about 5 inches, or a thickness (before being compressed) of about 2 inches to about 4 inches. More preferably, the batting 36 of the trap 32 preferably has a width of about 3.75 inches and a thickness (before being compressed) of about 3.5 inches. The batting 36 can be supplied from rolls containing 32 linear feet per roll. Other widths, thickness and lengths are also within the scope of the present invention.

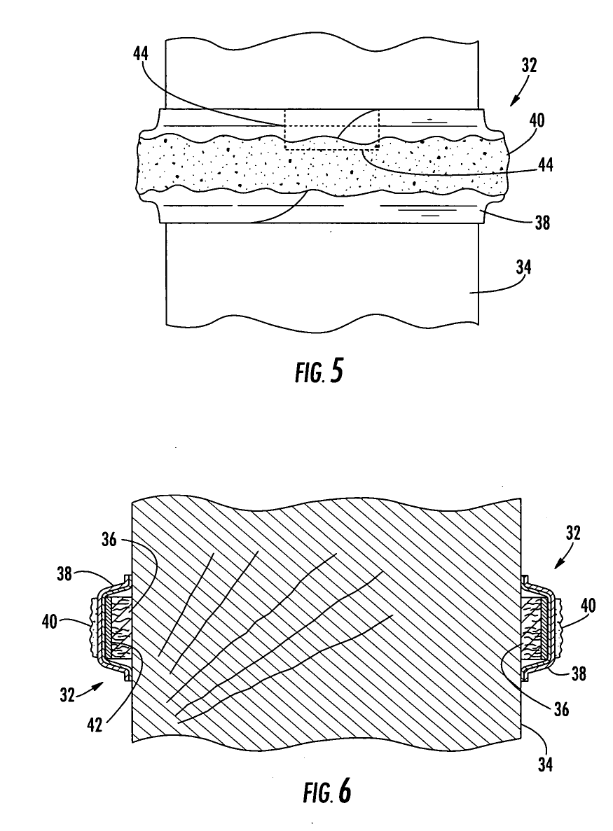

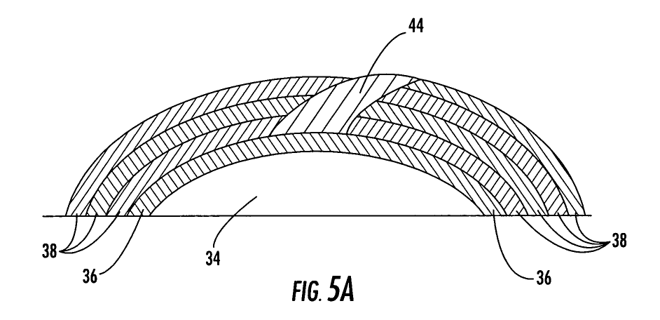

In accordance with an alternative embodiment of the present invention, the backing 42 can be omitted. In another alternative embodiment, the backing 42 can be applied to the batting 36 after the batting is applied to the trunk 34. More specifically, a fibrous batting 36 manufactured in dimensions suited for tree banding is installed around the circumference of the trunk 34 followed by a separate layer of a semi rigid backing material, with the result resembling the combined batting 36 and backing 42 illustrated in FIGS. 6 and 7.

In accordance with the exemplary embodiment of the present invention, after the fibrous batting 36 with the integral backing 42, or originally separate backing, is installed around the circumference of the trunk 34, then the backing is covered with one or more layers of the substantially stretchable and elastic film 38, which is installed under tension and preferably in one piece. More specifically, the entire backing 42 is preferably covered with at least two layers of the film 38, and the film is wrapped around the batting 36 and trunk 34 under tension. Preferably the batting 36 is not elongated while the film 38 is wrapped, and the film is elongated while the film is wrapped, with the elongating of the film causing the tension.

As a result of this tension, which preferably remains in the film 38 after installation, the film compresses the batting 36 so that the batting functions in its formfitting manner to fill any undulations in the trunk 34 and any fissures in the bark of the trunk. Stated differently, the elastic properties of the film 38 result in the film providing sustained tension that compresses the batting 36 against the trunk 34, causing the batting to fill any voids and fissures in the surface of the trunk and thereby block any path insects might otherwise find at the interface between the trap 32 and the trunk.

The plastic film 38 is preferably substantially wider than the width of the batting 36. As the film 38 is wrapped around the batting 36, and thereby the trunk 34, the film 38 is positioned such that equal amounts of the upper and lower margins of the film 38 lie above and below the batting. Because the width of the film 38 is preferably substantially greater than the width of the batting 36 and the film is applied under tension, the marginal portions of the film 38, which are respectively above and below the area covered by the batting 36, engage against the trunk 34 of the tree. More specifically, the film 38 is preferably applied so that the inner circumference of the medial portion of the film 38 is in direct face-to-face engagement with the backing 42, the inner circumference of the upper marginal portion of the film 38 is in direct face-to-face engagement with the trunk 34, and the inner circumference of the lower marginal portion of the film 38 is in direct face-to-face engagement with the trunk 34.

The film 38 may be transparent, or it can be opaque as a result of the film being any color that renders the film nontransparent, such as, but not limited to, the color black. The opaqueness of the film 38 and the arrangement of the marginal portions of the film as described above provides for concealment of the batting 36. That is, the batting 36 is substantially hidden from view and thereby protected from animals such as birds and squirrels that might otherwise see the batting and desire to remove it from the trap 32. For example, if the birds and squirrels were able to readily see the batting 36, they may attempt to remove it and use it in their nests.

An acceptable film 38 can be made of polymeric material. More specifically, an acceptable film 38, which can be formed or cut to size for the purposes of the first embodiment of the present invention, is the polyethylene stretch-film commonly used to bind pallets of boxes for trucking and shipping. The film 38 preferably has significant stretchability. For example, in one embodiment, the film 38 can be stretched out to approximately 250%. The film 38 can be about 3 inches wide to about 20 inches wide, or the film can be about 5 inches wide to about 15 inches wide. The film can be about 50 gauge (0.0005″) in thickness to about 150 gauge (0.0015″) in thickness, or the film 38 can be about 75 gauge (0.00075″) in thickness to about 120 gauge (0.0012″) in thickness. More preferably, the film 38 is about 10 inches wide and about 90 gauge (0.0009″) in thickness. Other widths and thickness can also be used. The film 38 can be provided on rolls containing any number of linear feet per roll. The film 38 can be replaced with other stretchable strips that provide the desired function(s). In one embodiment, the film 38 comprises a low density polypropylene film, such as a film distributed by J.C. Perry & Sons, Inc. of Baltimore, Md., under manufacturing no. PB080-20.

After encircling the batting 36 and trunk 34 with one or preferably more layers of the film 38, at least a part of the end of the film is preferably tucked behind the upper or lower edge of one or more of the previous layers of film to secure the film to the trunk 34. That is, the film 38 is frictionally attached to itself. An aspect of the manner in which the film 38 is frictionally attached to itself is generally similar to the manner in which a person would wrap a bath towel around their waist and then secure it by tucking an edge of the towel behind a previously wrapped portion of the towel. More specifically, the tucking of the film 38 is schematically shown in FIGS. 5 and 5A, which depicts an end 44 (which is hidden from view and, therefore, illustrated by broken lines in FIG. 5) of the film 38 tucked between the batting 36 and the underlying layers of the film 38 so that the end 44 is sandwiched therebetween. In other embodiments (not shown), the end 44 of the film 38 can also be tucked between two layers of underlying film 38 or between the batting 36 and the trunk 34. The tension in the film 38 preferably in combination with the tucking of the end 44 of the film keeps the trap 32 firmly in place on the trunk 34.

Preferably after the batting 36 and stretchable film 38 have been applied to the trunk 34, a coating of the sticky substance 40 is applied to the portion of the outermost surface of the stretchable film 38 which overlies the batting 36. This is the area that has been advantageously slightly stiffened by the backing 42 on the batting 36.

An acceptable sticky substance 40 is a durably sticky substance (e.g., a sticky substance that will remain tacky for at least a month and preferably longer under conditions in which a tree band trap is typically used). The durably sticky substance 40 can be a commercially available substance manufactured for insect traps 32, such as, but not limited to, Tanglefoot brand sticky substance or Tree Tanglefoot brand sticky substance, both of which are available from the Tanglefoot Company of Grand Rapids, Mich. Alternatively, the sticky substance 40 can be any number of other durably sticky substances, such as, but not limited to, bearing grease, petroleum jelly, or other jelly-like substances.

In accordance with the exemplary embodiment of the present invention, no adhesive, adhesive tape, or mechanical fasteners, such as staples or nails, are needed to hold the trap 32 together or to the trunk. In accordance with an alternative embodiment of the present invention, in addition to or as an alternative to frictionally attaching the film 38 to itself as described above, a length of adhesive tape can be placed across the exposed end of the film 38 to secure or further secure the film to itself. Another additional or alternative method for securing the film 38 is to encircle the film 38, and thereby the trunk 34, with a tape or wire band. Yet another additional method for securing the film 38 to itself is to affix it with one or more hooks. An alternative method for securing the film 38 directly to the trunk 34 is to drive one or more mechanical fasteners, such as nails, staples, or screws, into both the film 38 and the trunk 34.

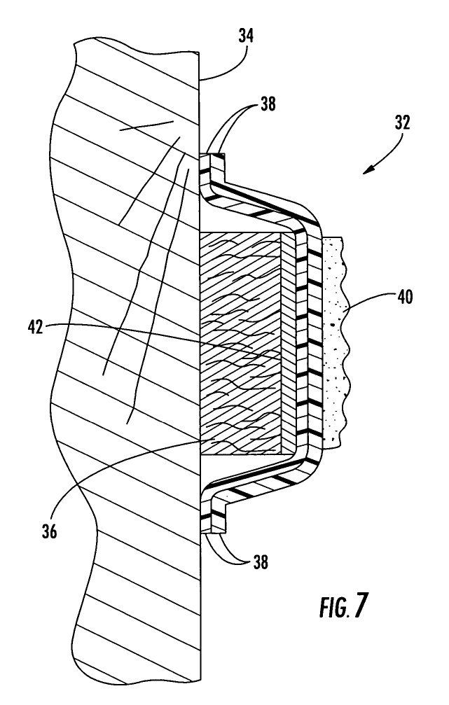

In some situations, it is possible that leaves and other debris may get stuck to the sticky substance 40 of the tree band trap 32 and impair its performance. One approach under such circumstances is to manually remove the debris from the trap 32. Another approach is to initially deflect the debris so that it does not become stuck to the sticky substance 40. For example, and in accordance with the exemplary embodiment of the present invention, the deflector 46 illustrated in FIGS. 8-11 can be used to deflect debris, such as leaves, so that it does not become stuck to the sticky substance 40 of the trap 32.

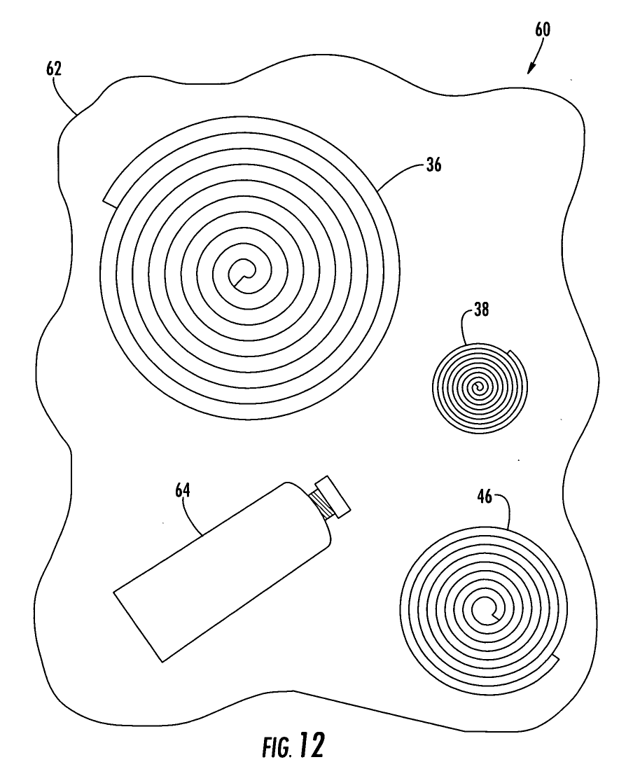

FIG. 8 illustrates the deflector 46 in a flattened configuration. As illustrated in FIG. 8, the deflector 46 is in the form a single strip of material that includes a crease line 48 extending between the opposite ends of the strip. The crease line 48 demarcates a base 50 of the deflector 46; the base extends from an edge of the deflector to the crease line. Also, a series of cuts 52 extend from an edge of the deflector 46 to the crease line 48. Only a few of the cuts 52 are identified by their reference numeral in FIG. 8 in an effort to clarify the view. Each line in FIG. 8 that extends perpendicular to the crease line 48 and is positioned between the opposite ends of the strip is a cut 52 that extends completely through the strip. As a result, the cuts 52 define a series of projecting pieces 54. Only a few of the projecting pieces 54 are identified by their reference numerals in FIGS. 8 and 11 in an effort to clarify the views.

The strip from which the deflector 46 is preferably formed is a semirigid material such as, but not limited to, a strip of polymeric material that is about 0.02 inches thick. In one example, the base is about 2 inches wide, and each of the projecting pieces is about 0.5 inches wide and about 4 inches long, with the width of the projecting pieces being perpendicular to the width of the base. The deflector 46 is preferably about as long as the outer circumference of the trunk 34 to which the deflector is to be mounted, so that the base 50 can be wrapped completely around the trunk and does not overlap itself very much if at all.

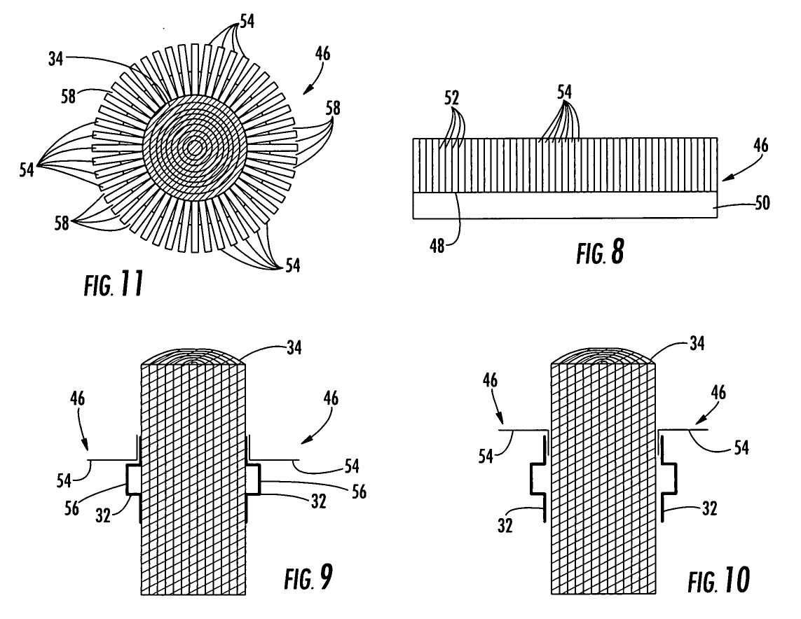

FIGS. 9 and 10 are vertical cross-sectional views that respectively illustrate two different arrangements for mounting the deflector 46 so that it deflects debris, such as falling leaves, away from the trap 32. More specifically, and as illustrated in FIGS. 9 and 10, it is preferred for the projecting pieces 54 to extend outwardly from the base 50 at about 90 degrees while the base 50 extends around the circumference of the trunk 34. As a result, the projecting pieces 54 catch or deflect debris, such as leaves, that fall toward the sticky substance 40 of the trap 32. Other angles between the base 50 and projecting pieces 54 that provide the desired result are also acceptable.

In each of FIGS. 9 and 10, the base 50 extends around the outer circumference of the trunk such that the base extends about vertically and is engaged to the film 38, and the projecting pieces 54 extend about horizontally. The projecting pieces 54 can slant somewhat downwardly from the horizontal and still provide their desired function. As illustrated in FIG. 9, the base 50 of the deflector is externally mounted to the trap 32 such that the base is engaged to the film 38 (FIGS. 5-7). The base 50 can be secured to the trap 32 and thereby the trunk 34 by encircling the base with a tape or wire band, such that the tape or wire band also encircles the trap and the trunk. Alternatively, one or more mechanical fasteners, such as nails, staples, or screws, can be driven into the base 50, film 38 and trunk 34. Alternatively or in addition, the base 50 can be mounted as illustrated in FIG. 10, by sandwiching the base between at least one layer of the film 38 and the trunk 34.

FIG. 9 also schematically illustrates that the projecting pieces 54 can advantageously be supported in their outward (e.g., horizontal) orientation by an upper shoulder of the annular, outwardly protruding portion 56 of the trap 32. The outwardly protruding portion 56 of the trap 32 is primarily the result of the thickness of the strip of batting 36 (FIGS. 6 and 7). In contrast, FIG. 10 schematically illustrates that the projecting pieces 54 can advantageously be supported in their outward (e.g., horizontal) orientation by an upper edge of the film 38.

FIG. 11 is a schematic view that is generally illustrative of top plan views of that which is illustrated in FIGS. 9 and 10 (i.e., of the deflector 46 in its installed configuration). As illustrated in FIG. 11, a series of elongate openings 58 are respectively defined between the projecting pieces 54. Only a few of the openings 58 are identified by their reference numeral in FIG. 11 in an effort to clarify the view. For each of the openings 58, the opening tapers so that it becomes wider at greater distances from the trunk 34.

FIG. 12 schematically illustrates a kit 60 for use in forming the trap 32 and the deflector 46, in accordance with the exemplary embodiment of the present invention. The kit 60 includes a container or package, which is illustrated in FIG. 12 as being in the form of a bag 62. More specifically, FIG. 12 is a top plan view of the upright and open bag 62. In FIG. 12, the bag 62 is schematically illustrated as being open at the top, and the unassembled components of the trap 32 and deflector 46 are schematically shown as being contained in the bag. Specifically, the batting 36 with the integral backing 42 (FIGS. 6 and 7), stretchable film 38, and deflector 46 are each shown in the form of separate rolls that are within the bag 62, and the sticky substance 40 (FIGS. 5-7) is within another container, namely a squeezable tube 64, that is also in the bag. The sticky substance 40 can be dispensed from the squeezable tube 64 by removing the cap from the tube and then squeezing the tube.

The components of the kit can be arranged differently within the bag 62 or in containers other than bags, and the container (e.g., bag 62) is preferably sealed closed to enclose its contents, and is subsequently opened when access to its contents is desired. The sticky substance 40 can be supplied in any conventional manner in which sticky substances are supplied. That is, and for example, the sticky substance 40 contained by the kit 60 can be packaged in containers other than squeezable tubes 64, such as tubs, cans, jars, etc. In addition, it may be desirable to omit one or more items from the kit 60, such as the deflector 46. For example, it may be desirable to omit the deflector 46 at certain times of the year, because it may only be desired to use the deflectors during the fall, when the majority of the leaves fall from trees. It may also be desirable to omit the deflector 46 when the kit 60 is to be used for a nondeciduous plant (e.g., an evergreen).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus that deters insects from traveling along a trunk of a plant, the apparatus comprising:
a formfitting substance engaging and extending at least substantially around the trunk's outer circumference;
a stretchable strip mounted to the trunk and having a length extending in a longitudinal direction and at least substantially around the formfitting substance's outer circumference, whereby the stretchable strip extends at least substantially around the trunk's outer circumference, wherein:
the stretchable strip is operative so that, after the stretchable strip is mounted to the trunk, the stretchable strip is under tension in the longitudinal direction as a result of the stretchable strip having been stretched,
the tension of the stretchable strip forces the formfitting substance against the trunk's outer circumference, and
a marginal portion of the stretchable strip extends at least substantially around the trunk's outer circumference at a position that is above or below the formfitting substance; and
a deterring agent extending at least substantially around the stretchable strip's outer circumference for deterring insects from traveling along the trunk.

2. The apparatus according to claim 1, wherein the formfitting substance is substantially nonadhesive and the stretchable strip is substantially nonadhesive.

3. The apparatus according to claim 1, wherein the deterring agent comprises a sticky substance that remains substantially tacky for at least about a month, whereby the sticky substance is for causing the insects to become adhered to the apparatus.

4. The apparatus according to claim 1, wherein:
the marginal portion of the stretchable strip is a first annular marginal portion of the stretchable strip that engages and extends around the trunk's outer circumference at a position above the formfitting substance; and
a second annular marginal portion of the stretchable strip engages and extends around the trunk's outer circumference at a position below the formfitting substance,
whereby the formfitting substance is substantially enclosed between the trunk and the stretchable strip.

5. The apparatus according to claim 4, wherein the stretchable strip is opaque, whereby the formfitting substance is substantially hidden from view.

6. The apparatus according to claim 1, wherein portions of the stretchable strip are in face-to-face engagement with one another, the stretchable strip is operative so that the face-to-face engagement between the portions of the stretchable strip at least partially causes the stretchable strip to be mounted to the trunk of the plant, the portions of the stretchable strip that are in face-to-face engagement with one another include first and second portions of the stretchable strip, and the first and second portions of the stretchable strip were initially spaced apart from one another along the length of the stretchable strip.

7. The apparatus according to claim 6, wherein the second portion of the stretchable strip is sandwiched between the first portion of the stretchable strip and structure selected from the group consisting of:
a third portion of the stretchable strip,
the formfitting substance, and
the trunk.

8. The apparatus according to claim 1, wherein the apparatus consists essentially of the formfitting substance, the stretchable strip and the deterring agent.

9. The apparatus according to claim 8, wherein the formfitting substance is a composite strip including a fibrous material mounted to a backing strip, and the fibrous material is in face-to-face engagement with the trunk of the plant.

10. The apparatus according to claim 1, wherein the stretchable strip is a polymeric film.

11. The apparatus according to claim 10, wherein the polymeric film has a width of about 10 inches and a thickness of about 0.0009 inches.

12. The apparatus according to claim 10, wherein the entire formfitting substance is covered with at least two layers of the polymeric film.

13. The apparatus according to claim 1, further comprising a second strip that is made of a material that is different from the formfitting substance and the stretchable strip, wherein the second strip is positioned between the formfitting substance and the stretchable strip so that a first side of the second strip is face-to-face engagement with the formfitting substance's outer circumference, and a second side of the second strip is in face-to-face engagement with the stretchable strip's inner circumference.

14. The apparatus according to claim 13, wherein:
the deterring agent is a sticky substance and is in face-to-face engagement with the stretchable strip's outer circumference;
the formfitting substance is fibrous;
the stretchable strip comprises a polymeric film; and
the second strip comprises wood pulp.

15. The apparatus according to claim 1 in combination with a deflector for deflecting debris away from the apparatus, with the deflector comprising a plurality of projecting pieces which extend away from the trunk and are arranged so that:
a plurality of elongate openings are respectively defined between the projecting pieces, and
for each of the openings, the opening tapers so that the opening becomes wider at greater distances from the trunk.

16. The combination according to claim 15, wherein the deflector further comprises a base from which the projecting pieces extend, and the base is mounted to the apparatus.

17. The combination according to claim 16, wherein the base is mounted to the apparatus at least partially as a result of the base being sandwiched between at least one layer of the stretchable strip and the trunk.

18. A method for deterring insects from traveling along a trunk of a plant, the method comprising:
positioning a formfitting substance so that the formfitting substance engages and extends at least substantially around the trunk's outer circumference;
then mounting a stretchable strip to the trunk, wherein the stretchable strip extends in a longitudinal direction and the mounting includes stretching the stretchable strip while wrapping the stretchable strip around the formfitting substance's outer circumference and thereby around the trunk's outer circumference, so that after the stretchable strip is mounted to the trunk, the stretchable strip is under tension in the longitudinal direction and forces the formfitting substance against the trunk's outer circumference; and
applying a deterring agent so that the deterring agent is carried by the stretchable strip and extends at least substantially around the stretchable strip's outer circumference for deterring insects from traveling along the trunk.

19. The method according to claim 18, wherein the mounting of the stretchable strip to the trunk includes causing portions of the stretchable strip to be in face-to-face engagement with one another so that the face-to-face engagement between the portions of the stretchable strip at least partially causes the stretchable strip to be mounted to the trunk of the plant.

20. The method according to claim 18, wherein the applying of the deterring agent occurs after the mounting of the stretchable strip.

21. A kit for use in deterring insects from traveling along a trunk of a plant, the kit comprising:
a strip of a fibrous formfitting substance for engaging and extending at least substantially around the trunk's outer circumference;
a stretchable strip for being mounted to the trunk and extending around the formfitting substance's outer circumference while the formfitting substance is engaging and extending substantially around the trunk's outer circumference, wherein the stretchable strip is operative so that, while the stretchable strip is mounted to the trunk and extending around the formfitting substance's outer circumference:
the stretchable strip can be under tension in the longitudinal direction as a result of the stretchable strip having been stretched, and
the tension of the stretchable strip can force the formfitting substance against the trunk's outer circumference; and
a container of a deterring agent that is for being applied to the stretchable strip's outer circumference, for deterring insects from traveling along the trunk.

22. The kit according to claim 21, further comprising a package containing the formfitting substance, the stretchable strip, and the container.

23. The kit according to claim 21, wherein:
the strip of the formfitting substance is separate from the stretchable strip, and
the strip of the formfitting substance is narrower than the stretchable strip.
